(19) United States
(12) Patent Application Publication
(10) Pub. No.: US 2017/0006839 A1
(43) Pub. Date: Jan. 12, 2017

(54) METHOD AND APPARATUS FOR SCATTERING ASHES USING BEES

(71) Applicant: Remember When, LLC, Aurora, CO (US)

(72) Inventor: Mathew King, Aurora, CO (US)

(73) Assignee: Remember When, LLC, Aurora, CO (US)

(21) Appl. No.: 15/205,756

(22) Filed: Jul. 8, 2016

Related U.S. Application Data
(60) Provisional application No. 62/191,044, filed on Jul. 10, 2015.

(51) Int. Cl. A01K 47/06; A61G 99/00

(52) U.S. Cl. CPC A01K 47/06; A61G 99/00

(57) ABSTRACT

This document describes methods and apparatuses for naturally scattering cremation remains over an area such as a garden, forest, park, open space, or graveyard while also creating a living memorial for the deceased. The methods use the natural actions of bees as the means for the scattering of the ashes.

### RELATED APPLICATION

This application claims the benefit of U.S. Provisional Application No. 62/191,044, filed Jul. 10, 2015, which application is hereby incorporated by reference.

### INTRODUCTION

The popularity of cremation is growing within modern society as an alternative to preserving bodies and burying them in coffins. Cremation is also becoming a popular method of dealing with pet remains. Cremation is usually less expensive and more ecological than burial. It also offers living individuals an opportunity to keep some of the deceased's ashes close to them.

Often a memorial is created at the location of the cremated remains to commemorate the deceased's life and provide a focal point to connect with the deceased's spirit. In death, many individuals wish to continue a connection or link to the living world. This connection may be spiritual between the deceased and their relatives or the connection may take a more physical form such as between the deceased's remains and nature.

### BRIEF DESCRIPTION OF THE DRAWINGS

The following drawing figures, which form a part of this application, are illustrative of described technology and are not meant to limit the scope of the invention as claimed in any manner, which scope shall be based on the claims appended hereto.

FIG. 1 illustrates, in a block diagram, a series of steps in the method of the distribution of ashes.

FIGS. 2A and 2B illustrate a front and a side view of an example of an embodiment of a memorial hive.

### DETAILED DESCRIPTION

This document describes methods and apparatuses for naturally scattering cremation remains over an area such as a garden, forest, park, open space, or graveyard while also creating a living memorial for the deceased. The methods use the natural actions of bees as the means for the scattering of the ashes.

The inventor has observed that bees, as the colony expands in a new hive, will remove the easily transportable contents, essentially cleaning out the hive over time in order to free up space for the colony. By providing an empty box suitable for use as a hive and placing the cremated remains within the empty box, the inventor essentially creates a passive mechanism for naturally scattering those cremated remains. The hive also acts as a living memorial for the deceased that can be located in a place of special significance to the deceased or the deceased's family.

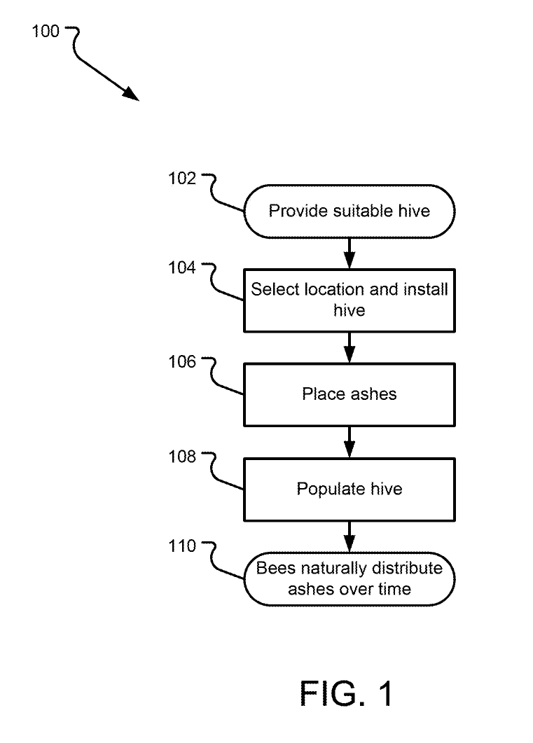

In general, the method can be understood as a series of steps as illustrated in FIG. 1. First, a hive is either made or provided, illustrated by operation 102 in FIG. 1. Examples of particularly suitable hives and hive construction are described further below.

The hive is installed in the selected area over with the ashes are to be scattered, as illustrated by the selection operation 104. Typical bees range over an area roughly estimated to within 300 feet of the hive's location. While it is not known if the bees distribute the ashes evenly over this area, it is presumed that with the hive as a center point, the ashes will be scattered from the hive outward in some radius up to 300 feet from the hive. For this reason, if a particular location such as the deceased's favorite garden, tree, picnic spot, park, creek or other landmark is the designated area for the living memorial, it would be preferable to place the hive within 50 feet, and more preferably within 25 feet, 10 feet or even 5 feet of the designated area.

In the embodiment of the method 100 illustrated, next an ash placement operation 106 is performed in which the ashes are placed within the installed hive. In many cases this will be done as part of a ceremony to honor the deceased. In an alternative embodiment (not shown), the ashes may be placed within the hive prior to the installation of the hive, for example, as part of a public memorial service. This alternative embodiment may allow the memorial service and ash placement operation 106 to be performed before as many of the bereaved as possible even though the final resting place may be remote from the memorial location. The hive and ashes may then be easily transported to the final location after the service.

Finally, bees are induced to take up residence in the hive in a final, populate hive operation 108. In an area with active bee populations, the act of installing a box suitable for bees may be enough to induce a swarm to take up residence in the hive. All that will then be necessary is patience in awaiting a swarm's arrival. Alternatively, a swarm may be procured and actively placed in the hive, as is commonly done in apiaries.

As soon as the bees take up residence and the hive begins to grow, the bees will begin to naturally disperse the cremation remains in the area around the hive without any further human interaction. This is illustrated in FIG. 1 by the distribution operation 110. However, the distribution operation 110 is a natural outcome of the bees' residence in a hive containing ashes.

Such a living memorial may be enhanced by provided a memorial plate or other device indicating the identity of the deceased. Such a device may be placed on, or near, the hive before or after the bees take up residence.

The reader will understand that the particular order of steps discussed above is unimportant and any reorder, substitution or combination of steps is possible as long as the final result of ashes in an installed hive having bees is achieved. For example, in an embodiment, the ashes may not be placed within a hive until a swarm is present. At the first stages before the swarm has fully moved into a hive, introduction of cremated remains is possible, particularly if the hive is constructed with an access door (in addition to the bee aperture) for that purpose.

In this embodiment, the memorial hive may be part of an institution such as a cemetery, university, school, military base, sports facility, local, state, or national park, or any other venue where people may wish to have their ashes spread on a regular or semi-regular basis. The use of the memorial hive may be scheduled and/or purchased in advance in a way similar to how grave plots are contracted. In such an institutional use, a memorial plaque or other remembrance marker may include a list of all the deceased whose ashes have been distributed over that location.

In order to maintain the health of a memorial hive, additional actions may be taken. For example, a local water source is important to the health of a hive and providing such a source within the designated area may be part of the method 100, for example as a part of the installation operation 104. Preferably, such a water source will keep the water moving as bees prefer non-stagnant water. Thus, one or more of a fountain, bubbler, or dripping water feature may be provided. In addition, bees need to access the water and providing significant amount of shoreline area where bees may safely land on a dry surface and then access the water is preferred. This may be done by providing floating surface objects. Again, as with the hive construction, it has been determined that natural cedar wood is beneficial in the construction of a water feature to support a healthy hive.

Other actions that can be taken include to plant mint around the hive. Mint is a natural defense against many common pests that afflict bees, especially tracheal mites. By planting mint around the base of a hive and/or near the water source, the overall health of the hive may be improved.

A memorial hive may be any vessel, box, or device attractive and suitable for a beehive. In a particular embodiment, the memorial hive is a vessel in the form of a box of natural cedar in which all parts of the box are at least 1.5 inches thick, and preferably 2 inches think. Each of the walls may made of a single cedar board or multiple, smaller boards connected in some way.

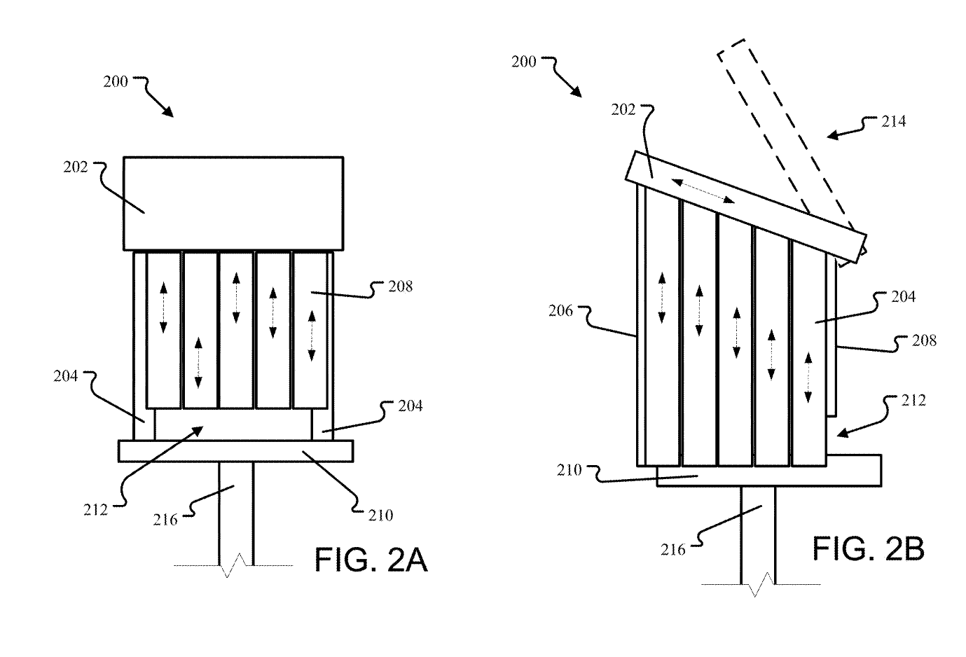

FIGS. 2A and 2B illustrate a front and a side view of an example of an embodiment of a memorial hive. The hive box 200 has a slanted roof 202, four side panels including a back 206, two side panels 204, a front panel 208, and a floor 210. The roof 202 and the floor 210 are depicted as being a single piece of wood, while the other panels 206, 204, 208 are shown as being made of multiple small boards, such as 2×4 studs. However, any size and number of boards may be for any of the panels of the hive, as long as the desired thickness and size is maintained.

Cedar is particular beneficial and attractive to bees and makes a pleasant memorial. It appears cedar's properties in warding off certain pests such as mites, is particularly attractive to bees. It should be noted that the grain of the cedar should be aligned vertically or at an angle in all of the panels including in the slanted roof, the back, sides and front panels. To illustrate this, dashed arrows indicating the direction of the wood grain are provided on some of the boards in FIGS. 2A and 2B. It is also beneficial to provide the same vertical, or at least non-horizontal, orientation in the floor as well. This prevents water from pooling and helps the natural transport of water around and out of the hive, thereby reducing the possibility of mold and also assisting the natural evaporation of water from the nectar to facilitate the creation of honey. The slanted roof further assists in the shedding of rain and snow and may be used to provide some protection to the landing site created by the floor 212 extending beyond the front wall.

At least one aperture 212 is provided for allowing the bees to enter and exit the box. The aperture may be as simple as a hole of between 1 inch and 5 inches in diameter located in one of the panels, in this case the front panel. In the embodiment shown, the aperture 212 takes the form of a rectangular opening between the front wall 208 and the floor panel 210. This also allows the floor panel 210, which extends beyond the front wall 208, to act as a landing point for the bees. However, the aperture can be located in any panel as desired.

A second aperture or closable access door may be provided, such as for the easy insertion of the cremated remains in the hive. For example, one of the side panels, the roof, or a portion of any of these may be initially movable to allow the ashes to be placed inside. After placement of the ashes through an access door, the door may be sealed or simply closed before or after the bees have arrived. In the embodiment illustrated, the roof 202 can be opened to gain access to the hive as shown by reference arrow 214. In this embodiment, a hinge may or may not be provided to assist in the opening and closing of the access panel.

For the purposed of this application, a hive should be between 2 and 10 gallons in interior volume. Hives with from 4 and 6 gallons are particularly suitable for this application. The inventor has determined that an interior volume of from 4.5 to 5.5 gallons in size is particularly attractive to a swarm of bees looking for a new home.

Care should be taken to not use any toxic materials in the construction of the box. In particular, plastic, paint and certain metals such as copper and iron (because of the rust) are detrimental to bee health and swarms may avoid an otherwise attractive hive if they encounter these materials. Therefore, if possible, a hive should be made without plastic, without paint, without copper, and without iron. If possible, all fasteners or other components of the hive that are not cedar should be stainless steel or some other non-toxic material.

A hive should be suspended at least two feet above the ground. For a living memorial, hives installed between 3 and 10 feet are suitable. This can be done by attaching the hive to a pole, tree, house, or other structure. Alternatively, a hive may be suspended from a tree or other structure using a rope (again, preferably natural such as hemp), or attached to separable hive stand, such as a single pole table stand. In the embodiment shown in FIGS. 2A and B, a pole 216 is shown that holds memorial hive at the appropriate height above the ground.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. For example, any powder or aggregate may be scattered using the above method. Numerous other changes may be made which will readily suggest themselves to those skilled in the art and which are encompassed in the spirit of the disclosure.

What is claimed is:

1. A method of scattering cremation remains over a designated area comprising:
placing the cremation remains in a vessel;
installing the vessel in the designated area; and
inducing a swarm of bees to establish a beehive in the vessel, thereby causing the bees to disperse the cremation remains over the designated area over time.

2. The method of claim 1 further comprising:
constructing a water source for the bees within the designated area wherein the water source includes one or more of a fountain, bubbler, floating surface objects, and natural cedar wood.

3. The method of claim 1 further comprising:
wherein the vessel is a box of natural cedar in which all parts of the box are at least 1.5 inches thick, the box having a slanted roof, four side panels including a back, two sides, a front panel, and a floor and at least one aperture for allowing the bees to enter and exit the box and wherein the grain of the cedar is aligned vertically in the slanted roof, the back, sides and front panels.

4. The method of claim 1 further comprising:
wherein the vessel is suspended at least two feet above the ground by a pole, a rope, an RV table, a wire, or a post.

5. The method of claim 1 further comprising:
wherein the box is provided with a memorial plate identifying the cremated remains.

6. The method of claim 1 further comprising:
wherein the designated area is a garden, park, open space, or graveyard.

7. The method of claim 1 further comprising:
wherein inducing further comprises obtaining a swarm of bees and installing them into the vessel after the placing and installing operations.

8. The method of claim 1 further comprising:
wherein the vessel holds between 2 and 10 gallons in volume and is preferably about 5 gallons in volume.

9. The method of claim 1 further comprising:
wherein the vessel is made without plastic and without paint.

10. The method of claim 1 further comprising:
wherein the vessel comprises only stainless steel fasteners and natural cedar wood.
